(19) United States
(12) Patent Application Publication
(10) Pub. No.: US 2025/0182931 A1
(43) Pub. Date: Jun. 5, 2025

(54) ELECTRICAL MAINS CABLE

(71) Applicant: HARTING ELECTRIC STIFTUNG & CO. KG, Espelkamp (DE)

(72) Inventors: Markus FRIESEN, Espelkamp (DE); Felix LOSKE, Minden (DE)

(21) Appl. No.: 18/841,277

(22) PCT Filed: Feb. 9, 2023
(86) PCT No.: PCT/DE2023/100109

§ 371 Date: Aug. 23, 2024

(30) Foreign Application Priority Data
Feb. 28, 2022 (DE) 10 2022 104 664.8

(51) Int. Cl. H01B 9/00; H01Q 1/22; H01R 13/719

(52) U.S. Cl. CPC H01B 9/003; H01Q 1/2216; H01R 13/719

(57) ABSTRACT

A mains cable is provided to enable an electrical device, which has a panel connector for connection to a mains supply, to be identified by a reader of a smart socket of the mains supply. The mains cable has an antenna on each of its two connectors, wherein these two antennas are interconnected by an information line of the mains cable. An RFID tag is mounted in the panel connector of the electrical device, the information of the RFID tag is read by the first antenna of the mains cable and transmitted via the information line to the second antenna of the mains cable, and from there to a reader antenna arranged in or on the socket. At least the second antenna and the reader antenna are near-field antennas, in order to prevent crosstalk to possible neighboring sockets.

### BACKGROUND

### Technical Field

The present disclosure relates to an electrical mains cable.

Such mains cables are used to supply power, i.e., to connect electrical devices to a mains supply, i.e., to an electrical power distribution system. Such a mains cable has a first end and a second end. A first electrical connector for connecting the mains cable on the device side to a built-in panel connector installed in a housing of the respective electrical device is arranged at the said first end, wherein this panel connector is embodied as a cooling device plug or has at least one cooling device plug. A second electrical connector for connecting the mains side of the mains cable to a socket of the electrical power distribution system is arranged at the second end of the mains cable.

For example, the first electrical connector of the mains cable can be a so-called cooling device electrical connector, which is embodied as a cooling device socket connector for reasons of contact protection. The second electrical connector of the mains cable can be a Schuko (“protective contact”) plug. Accordingly, the socket can be a Schuko socket. The mains cable may be a cooling device connection cable.

The first and second electrical connectors of the mains cable each have several, such as two or three, plug contacts. The plug contacts of the first electrical connector may be embodied as pin contacts and the plug contacts of the second electrical connector may be designed as socket contacts.

Each of the plug contacts of the first electrical connector is electrically connected to one of the plug contacts of the second electrical connector via an electrically conductive core, e.g., stranded wire, of the mains cable either for the purpose of transmitting electrical energy or for the PE (“Protective Earth”) connection. These cores are surrounded by insulation. In addition, the aforementioned electrical conductors are surrounded by a common sheathing of the mains cable, which has at least one further insulation and may additionally also have a shielding foil and/or braided shield embedded in it.

### Description of the Related Art

Intelligent sockets, also known as “smart sockets,” are known in the prior art, for example from publication DE 10 2015 009 361 A1. These smart sockets are used between an electrical supply network, such as a 220V AC network, and an electrical device of which the electrical connector is connected to a socket box of an adapter plug.

Smart sockets are equipped with a switching element, embodied as a microcontroller or processor, and a data transmission unit, also known as a communication module. The switching element can be used to switch the electrical device connected to the socket on or off. In some embodiments, the processor or controller is also intended to determine the electrical power consumed by the connected device.

It is necessary to know which device or device type is located in the socket insert in order to apply the appropriate control logic for the device and, if necessary, to display it.

To do this, the device type is selected manually, for example from a list provided, and set at the respective socket.

Another approach to setting the device type is based on the fact that the data transmission unit integrated in the smart socket transmits the information on energy consumption to an external data processing device. From this, the characteristics of the respective energy consumption of the plugged-in device are processed on data processing equipment connected to the smart socket and used to deduce the device type of the plugged-in device.

However, the procedures described above are prone to errors or require additional hardware or software.

The publication mentioned at the outset set itself the task of specifying, in a simple manner, a device of which the smart socket enables automated detection of an electrical device, such as its device type, received by the socket insert of the socket.

As a solution, the publication proposes a device for automatically detecting an electrical device connected to a smart socket. The smart socket has a socket insert arranged in the socket for receiving an electrical connector of the electrical device, an electrical connection of the socket to an electrical supply network, for example a 220V AC network, at least one switching element via which the electrical device connected to the socket insert can be switched on or off, and a communication module which is integrated in the socket and which interacts with a remote data processing device via a further connection.

According to the teaching of this publication, the solution to the aforementioned problem is to be provided by the following features:

The electrical connector of the electrical device to be plugged into the socket insert is equipped with a radio tag on which data relating to the device type of the electrical device to be connected to the smart socket is stored. The radio tag can be embodied as an RFID tag or NFC tag, for example.

The smart socket is equipped with a reader, for example an RFID or an NFC tag reader, which enables communication between the radio tag and the reader when the connector is plugged in, so that the reader detects a signal with modeled data relating to the device type of the electrical device plugged into the socket from its radio tag without contact and transmits it to a remote data processing device. This modeled data can be, for example, a unique ID number of the device plugged into the socket insert and/or data packets relating to the plugged-in device.

A development is disclosed in which the smart socket is set up to transmit information on the energy consumption of the connected electrical device to the remote central data processing device via the communication module.

A disadvantage of this prior art is that many electrical devices do not have their own mains cable permanently connected to the device with an electrical connector, e.g., earthed mains plug, at the end. Instead, many devices are equipped with a panel connector built into their device housing, e.g., a built-in cooling device plug, which is intended to be used with a matching mains cable, e.g., a cooling device connection cable, wherein the mains cable is equipped with a first electrical connector at a first end and a second electrical connector at the other end.

By their very nature, such devices are not suitable for identifying themselves to a smart socket by a radio tag, e.g., an RFID tag or an NFC tag, which is arranged in or on their second electrical connector, such as their Schuko plug. After all, these mains cables, which may be the aforementioned IEC mains cables, are naturally exchangeable, i.e., interchangeable, so that correct assignment of the respective tag to the associated device is not guaranteed.

### BRIEF SUMMARY

Embodiments of the present disclosure provide an electrical device, which has a panel connector for connection to a mains supply by an electrical mains cable, to be identified by a reader which has a reader antenna arranged in or on a socket of the mains supply of an electrical power distribution system. This socket may be a so-called smart socket. In some embodiments, the panel connector of the electrical device may be embodied as a cooling device plug or can have at least one such cooling device plug, so that the panel connector is a cooling device panel plug. The power distribution socket on the mains side may be embodied as a so-called Schuko socket (“protective contact socket”).

An electrical mains cable is used to connect an electrical device to an electrical power distribution system.

At its first end, the mains cable has a first electrical connector for plugging into a panel connector of the electrical device. In some embodiments, this first electrical connector of the mains cable may be a cooling device socket connector for reasons of contact protection.

The mains cable has a second electrical connector at its second end for plugging into a so-called smart socket of the power distribution system. In some embodiments, this second electrical connector may be a Schuko plug (“protective contact plug”) and the aforementioned socket-as already mentioned-may be a Schuko socket (“protective contact socket”).

The smart socket can be distinguished by the fact that it is equipped with at least one switching element (“switch”) embodied as a microcontroller or processor and a data transmission unit, also known as a communication module. The smart socket may also have a current meter.

Each of the two electrical connectors of the mains cable has at least two electrical plug contacts as power transmission contacts for electrical power transmission, wherein each of the two plug contacts of the first electrical connector are electrically conductively connected to a plug contact of the second electrical connector via an electrically conductive core (e.g., usually referred to as “phase” and “neutral conductor” in technical jargon) of the mains cable. In some embodiments, each of the two electrical connectors may also have at least one PE (“Protective Earth”) contact, wherein these PE contacts are connected to each other via a PE core (“ground wire”) of the mains cable.

According to the present disclosure, the mains cable additionally has at least one further electrical line, namely an identification line, for transmitting identification information. At its first end, the information line has a first antenna arranged in or on the first electrical connector of the mains cable. This first antenna is used for wireless reception of said identification information from a radio tag arranged in or on the panel connector of the device. The identification line has, at its second end, a second antenna arranged in or on the second electrical connector of the mains cable for wireless transmission of the identification information to a reader antenna of a reader arranged in or on the smart socket.

Advantageous embodiments of the present disclosure are given in the dependent claims and the following description.

The present disclosure has the advantage that electrical devices can also be identified that do not have a permanently connected power supply cable, but instead have a connection, for example the aforementioned panel connector, for a separate mains cable,

A further advantage is that swapping several mains cables of this kind does not impair the correct identification of the electrical device, since the identification of the radio tag, e.g., the RFID tag or the NFS tag, attached in or on the panel connector of the electrical device is received by the first antenna of the mains cable, transmitted to the second antenna of the mains cable via the identification line of the mains cable, and sent by the second antenna of the mains cable to the reader antenna of the reader arranged in or on the smart socket. Such mains cables are therefore interchangeable.

In one advantageous embodiment, at least the second antenna of the mains cable and the reader antenna are each near-field antennas, which are distinguished in that they have a common range of only a few cm (centimeters) in the described application, for example a common range of less than 10 cm, such as less than 5 cm, less than 4 cm, such as less than 3 cm, for example 2.5 cm and less.

A further advantage is therefore that several such devices can also be identified unmistakably, i.e., there is no risk of confusion if the sockets of the mains supply are arranged next to each other and the radio signals between the respective second antennas and reader antennas do not interfere with each other and therefore there is no crosstalk to the reader antenna of the respective neighboring socket. The cables transport the identification signal from the radio tag of the respective device to the reader antenna of the respective socket, so that the electrical device can be located several meters away from the associated socket and correct identification is still guaranteed without interference via the near-field antennas. The electrical devices are located far enough away from each other. In one embodiment, the radio tag attached to the respective electrical device also has a near-field antenna, so that crosstalk is also advantageously excluded at this point.

In one embodiment, at least the first and/or the second antenna of the mains cable can be active, i.e., can have electrical amplification.

This has the advantage that the transmission of the signal is reliable. In some embodiments, the longer cable lengths of the mains cable of more than 5 m (meters), such as more than 10 m, more than 15 m and even 20 m and more can be guaranteed with a high signal integrity.

In one embodiment, the identification line may be used bidirectionally. This enables more complex identification processes between the radio tag and the reader.

In one advantageous embodiment, the identification line may be embodied as a further pair of electrical cores, e.g., as a pair of stranded wires, within the mains cable. This allows a comparatively large conductor cross-section and enables good transmission properties of the identification line. The identification line is then well protected against environmental influences. This technology is therefore ideal for long cable lengths and/or use in so-called “harsh environments,” i.e., those exposed to dirt, moisture, extreme heat or cold, aggressive chemicals, etc.

In one alternative embodiment, the identification line may be applied as an electrically conductive coating to the insulation of the sheathing of the mains cable with comparatively little manufacturing effort, for example in an MID process or any other coating process. This is suitable for relatively short mains cables in less harsh environments. It is also possible to retrofit existing systems. The identification line embodied as an electrical coating can, for example, consist of two separate, electrically conductive conductor tracks.

In one embodiment, the first and/or second antenna can have a three-dimensional structure. This has the advantage that-depending on the circumstances-a well adapted and therefore effective coupling can be achieved.

In one embodiment, the first and/or second antenna may be inserted into the respective first and/or second electrical connector of the mains cable, e.g., by overmolding. This has the advantage that they are protected from environmental influences. Such mains cables are suitable for use in the aforementioned harsh environments.

Alternatively, the first and/or second antenna may also be attached to the first and/or second connector from the outside, e.g., by gluing or using an MID process, for example. This reduces manufacturing costs and enables existing systems to be retrofitted.

The present disclosure may be used advantageously in industrial plants, office buildings, hospitals and other safety-relevant areas. The present disclosure may be used to ensure compliance with safety-related standards (e.g., DGUV V3), even for commercially available electrical devices that do not have power supply cables attached to them, via smart sockets. For example, the socket in question can simply be switched off if the device connected to it does not have the required certification. An overload may also be avoided as a precaution and without negative consequences for the other loads by simply switching off the smart socket of the last-connected device (or a lower priority device) without affecting the other devices supplied by the same circuit.

Advantageously, all these possibilities can also be realized by the present disclosure for electrical devices which do not have a mains cable attached to them, but instead have a panel connector, e.g., a cooling device panel plug, for their power supply.

The present disclosure therefore advantageously serves to increase the level of safety in the aforementioned areas.

### BRIEF DESCRIPTION OF THE SEVERAL VIEWS OF THE DRAWINGS

Embodiments of the present disclosure are shown in the drawings and are explained in greater detail below.

FIG. 1 shows a schematic representation of a first mains cable.

FIG. 2 shows a system comprising an alternatively embodied second mains cable, an electrical device and a power supply with a smart socket.

Some of the figures contain simplified, schematic representations. In some cases, identical reference signs are used for like but possibly non-identical elements. Different views of the same elements may be scaled differently. Directional indications such as “left,” “right,” “top” and “bottom” are to be understood with reference to the respective figure and may vary in the individual illustrations in relation to the object shown.

### DETAILED DESCRIPTION

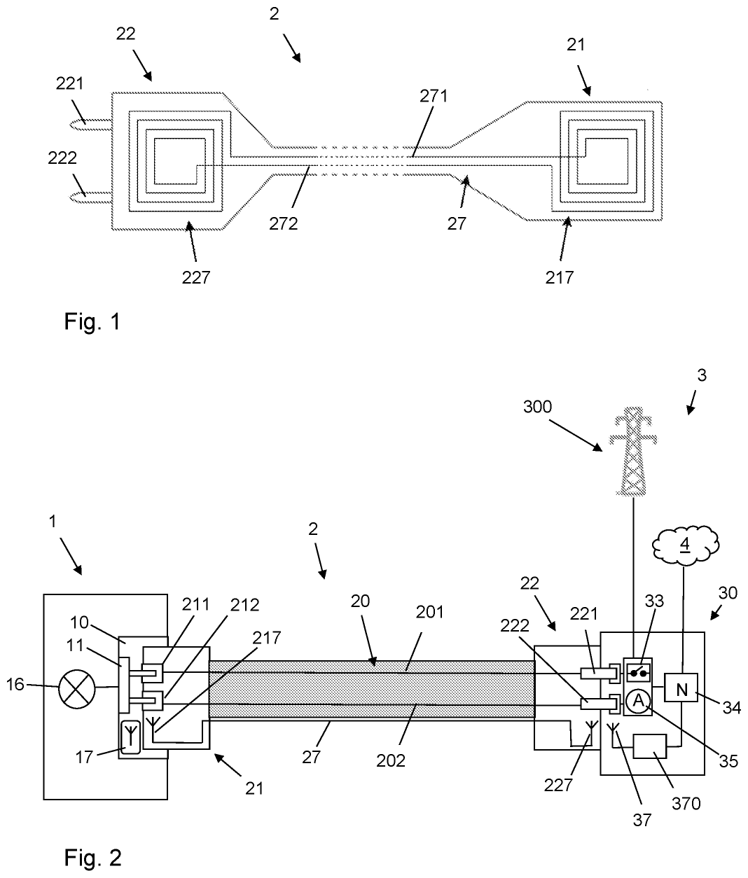

FIG. 1 shows a schematic representation of a first mains cable 2. The first mains cable 2 is a cooling device connection cable. The first mains cable 2 has a first electrical connector 21 (shown on the right in the drawing), namely a cooling device electrical connector, which is embodied as a socket connector, i.e., a cooling device socket connector, for protection against accidental contact. This first electrical connector 21 is intended for plug-in connection to a panel connector 10 installed in a housing of an electrical device 1, namely a cooling device panel plug. The first mains cable 2 has a second electrical connector 22, shown in the drawing on the left, which is embodied as a Schuko plug and is intended to be plugged into a smart socket 30. The first electrical connector 21 has two socket contacts 211, 212, which are not shown in this illustration but are shown in the following illustration, as power transmission contacts, namely a first 211 and a second 212 socket contact. On the second electrical connector 22, the two pin contacts 221, 222 are shown as electrical energy transmission contacts. However, for reasons of clarity, the PE connections of both connectors 21, 22 and a PE core connecting them are not shown here. For reasons of clarity, the representation of a first pair of cores intended for electrical energy transmission, consisting of a first core 201 (“phase”) and a second core 202 (“neutral conductor”), which connects the socket contacts 211, 212 with the pin contacts 221, 222 for electrical energy transmission, has also been omitted.

However, an identification line 27 is shown here, which is embodied as a second pair of cores and runs inside the cable, i.e., is surrounded by a sheathing of the first mains cable 2. The identification line 27 connects a first antenna 217, which is arranged at the first electrical connector 21, to a second antenna 227, which is arranged at the second electrical connector 22. For this purpose, a first 271 and a second 272 core of the identification line 27 electrically conductively connect the two ends of the two antennas 217, 227 to each other.

FIG. 2 shows a somewhat more comprehensive arrangement. The drawing on the left shows the electrical device 1 to be connected to the mains supply 3 (electrical power distribution).

This electrical device 1 has an unspecified load 16 and a panel connector 10, which has a cooling device plug 11. In addition, a radio tag 17, which is embodied as an NFC tag, is attached to the panel connector 10.

The mains supply 3 comprises a power supply access 300 and the smart socket 30 electrically conductively connected thereto. In addition to electrical plug contacts, which are not described in greater detail for reasons of clarity and are embodied as sockets for protection against accidental contact, this smart socket 30 has an electrically conductively connected switch 33 and a current meter 35 (“ammeter”) connected to it, which are connected to the power supply access 300 on the primary side. The smart socket 30 has a network interface 34 as a data transmission unit and a reader 370, namely an NFC reader 370 and a reader antenna 37 connected thereto.

The electrical device 1 is connected via an alternative, second mains cable 2 to the smart socket 30, i.e., the first connector 21 of the second mains cable 2 is plugged into the panel connector 10 of the electrical device 1 and the second connector 22 of the second mains cable 2 is plugged with the smart socket 30.

In the second mains cable 2, the first pair of cores 20, consisting of a first 201 and a second 202 core, intended for electrical energy transmission is shown in this illustration. Its two cores 201, 202 (“phase,” “neutral”) run inside the sheathing of the cable 2. The antennas 217, 227 of the first 21 and second 22 electrical connectors and the identification line 27 connecting them are shown here symbolically. The antennas 217, 227 are applied to the respective connectors 21, 22 by an MID process. The identification line 27 is also applied to the outside of the sheathing of the second mains cable 2 using an MID process.

Using such a first or second (alternative) mains cable 2, it is possible not only to supply power to electrical devices 1 that have a panel connector 10 for the power supply, but also to identify them via the smart socket 30. This allows such devices 1 to be legitimized for use in safety-relevant areas. The devices 1 can also be assigned a maximum power consumption, either by measurement, e.g., via the current meter, or by their specification obtained via the data interface, e.g., from the Internet 4. This means that an individual socket 30 in the power grid can be switched off in a targeted and timely manner to avoid an overall overload without affecting other sockets in the same power distribution.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An electrical mains cable for connecting an electrical device to an electrical power distribution system, comprising:
a first electrical connector provided at a first end of the electrical mains cable for plug-in connection to a panel connector of the electrical device, and
a second electrical connector provided at a second end a of the mains cable for plug-in connection to a smart socket of the power distribution system,
wherein each of the two electrical connectors of the mains cable has at least two electrical plug contacts as power transmission contacts,
wherein each of the two electrical plug contacts of the first electrical connector is electrically conductively connected to a respective one of the electrical plug contacts contact of the second electrical connector via a respective electrically conductive core of the mains cable,
wherein the mains cable has at least one electrical line provided as an identification line configured to transmit identification information,
wherein the identification line has at a first end thereof a first antenna arranged in or on the first electrical connector which is configured to wirelessly receive identification information from a radio tag arranged in or on the panel connector of the electrical device, and
wherein the identification line has at a second end thereof a second antenna arranged in or on the second electrical connector which is configured to wirelessly transmit the identification information to a reader antenna of a reader arranged in or on the smart socket.

2. The electrical mains cable as claimed in claim 1, wherein the second antenna of the mains cable and the reader antenna are each near-field antennas.

3. The electrical mains cable as claimed in claim 1, wherein the first and/or the second antenna of the mains cable is active.

4. The electrical mains cable as claimed in claim 1, wherein the identification line can be used bidirectionally.

5. The electrical mains cable as claimed in claim 1, wherein the identification line comprises an electrical core pair within the mains cable.

6. The electrical mains cable as claimed in claim 1, wherein the identification line is applied as an electrically conductive coating to an insulation of a sheathing of the mains cable.

7. The electrical mains cable as claimed in claim 1, wherein the first and/or the second antenna have a three-dimensional shape.

8. The electrical mains cable as claimed in claim 1, wherein the first and/or the second antenna are inserted into the first and/or the second electrical connector of the mains cable.

9. The electrical mains cable as claimed in claim 8, wherein the first and/or second antenna is injected into the first and/or second electrical connector.

10. The electrical mains cable as claimed in claim 1, wherein the first and/or second antenna are applied to the first and/or second electrical connector from an outside by gluing or in an MID process.
